(19) United States
(12) Patent Application Publication
(10) Pub. No.: US 2004/0237638 A1
(43) Pub. Date: Dec. 2, 2004

(54) Method for testing a current regulator in a electronically controllable valve in a hydraulic vehicle brake system

(76) Inventors: Ralf Reviol, Dietzenbach-Steinberg (DE); Ralph Gronau, Wetter (DE); Tobias Scheller, Hofbieber (DE); Andreas Neu, Kuhardt (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/486,497

(22) PCT Filed: Aug. 9, 2002
(86) PCT No.: PCT/EP02/08923

(30) Foreign Application Priority Data
Aug. 11, 2001 (DE) 101 39 611.2

(51) Int. Cl. G01L 5/28

(52) U.S. Cl. 73/121

(57) ABSTRACT

A method for testing a current regulator of an electronically controllable valve in a hydraulic vehicle brake system, the current regulator is tested by way of actuation with a testing current which is sufficiently small such that essentially there is no valve movement of the electronically controllable valve, with the result that no substantial hydraulic effect is produced on the vehicle brake system.

### TECHNICAL FIELD

The present invention generally relates to testing methods, and more particularly relates to a method for testing a current regulator of an electronically controllable valve in a hydraulic vehicle brake system.

### BACKGROUND OF THE INVENTION

Electronically controllable valves are provided in modern hydraulic brake systems for controlling the brake pressures in hydraulic vehicle brake systems.

It is known in the art to design these valves as ‘analogized electromagnetic valves’. The term ‘analogized electromagnetic valves’ herein and in the following refers to electromagnetic valves which, when actuated by a defined control current, adopt a defined switch position, for the purpose of adjustment of a defined volume flow of hydraulic fluid (brake fluid) by the valves. This implies that the valve, induced by corresponding actuation, can also adopt intermediate positions between a (fully) open position and a (fully) closed position, thereby adjusting a defined pressure gradient between the two sides of the valve at least in approximation.

### BRIEF SUMMARY OF THE INVENTION

A current regulator, which reliably adjusts the desired current, is required to actuate the electronically controllable valves. An adjustment of the desired brake pressure is no longer safeguarded upon failure of the current regulator.

In view of the above, an object of the present invention is to provide a method allowing safe testing of a current regulator of an electronically controllable valve in a hydraulic vehicle brake system.

This object is achieved by means of the features of the independent patent claims. Improvements of the invention are indicated in the dependent sub claims.

It is arranged for in the invention that the current regulator is tested by an actuation by means of a testing current that is so low that essentially no valve movement of the electronically controllable valve takes place, with the result that basically no hydraulic effect is produced on the system of the vehicle brake system.

The method of the invention is implemented for testing an analogized valve, in particular an analogized electromagnetic separating valve. The term ‘separating valve’ refers to a valve that allows interrupting a hydraulic connection between the master brake cylinder and the wheel brakes. The separating valve is arranged especially in a connecting line between the master brake cylinder and the wheel brakes.

It is provided by the invention that the testing operation is carried out in times when an intervention by the regulator is unnecessary and/or when a constant current is adjusted, with the testing current being superimposed on said adjusted current.

According to the invention, the testing operation comprises a comparison between a nominal current and a measured actual current which is preferably measured redundantly.

Preferably, the testing operation comprises a plurality of temporally separate comparisons.

The testing operation comprises individual nominal currents or purposefully adjusted current curves according to the invention.

According to the invention, testing is carried out prior to each application in order to ensure the safety of a correct functioning or timely deactivation of a regulator.

The electronically controllable valve of the invention includes a function for limiting the hydraulic pressure. Accordingly, a pressure limiting function necessary for the brake system, which has previously been realized by special mechanical/hydraulic means, is favorably realized by the analogized separating valve, with the result of rendering possible a more compact construction and reduction of components. To this end, the coils of the analogized valves are maximally so energized that they open when the predetermined pressure limit is reached. In this case, the vehicle brake system preferably has no mechanical/hydraulic pressure limiter. It can be avoided by disabling the regulator in the case of malfunction that the regulator provides an excessive amount of current, with the consequence that a pressure limiting function would no longer be ensured.

According to the invention, the brake system includes an active hydraulic brake force boosting device, wherein the driver can introduce brake pressure into a master brake cylinder by means of an operating device, preferably a brake pedal, and wherein the pressure introduced by the driver is boosted by means of an active hydraulic pressure boosting unit, in particular a hydraulic pump.

A preferred hydraulic brake system for implementing the invention therefore includes an operating device, preferably a brake pedal, a vacuum brake booster, an operable master brake cylinder and a pump, the pressure of which can be applied to at least one wheel brake of the vehicle, and by means of which hydraulic brake boosting is produced, wherein the pump on the inlet side (suction side) is connectable to the master brake cylinder by way of at least one hydraulic connection into which a change-over valve is inserted, and wherein the pump on the outlet side (pressure side) is connectable to at least one wheel brake of the vehicle by way of at least one hydraulic connection, and is connectable to the master brake cylinder by way of at least one hydraulic connection into which a separating valve is interposed.

When the point of maximum boosting of the vacuum brake booster is reached in the mentioned system with active hydraulic brake boosting, and when the driver continues to apply the brake pedal, then the hydraulic pressure increase unit—in the event of insufficient assistance by the vacuum brake booster—causes further pressure increase in order that the driver receives the desired brake power. Thus, at least part of the brake power assistance can be produced actively by means of the pressure increase unit in a method with ‘active’ hydraulic brake force boosting of this type.

### BRIEF DESCRIPTION OF THE DRAWINGS

FIG. 1 shows the device of the present invention by way of a brake system with active hydraulic boosting.

### DETAILED DESCRIPTION OF THE PREFERRED EMBODIMENTS

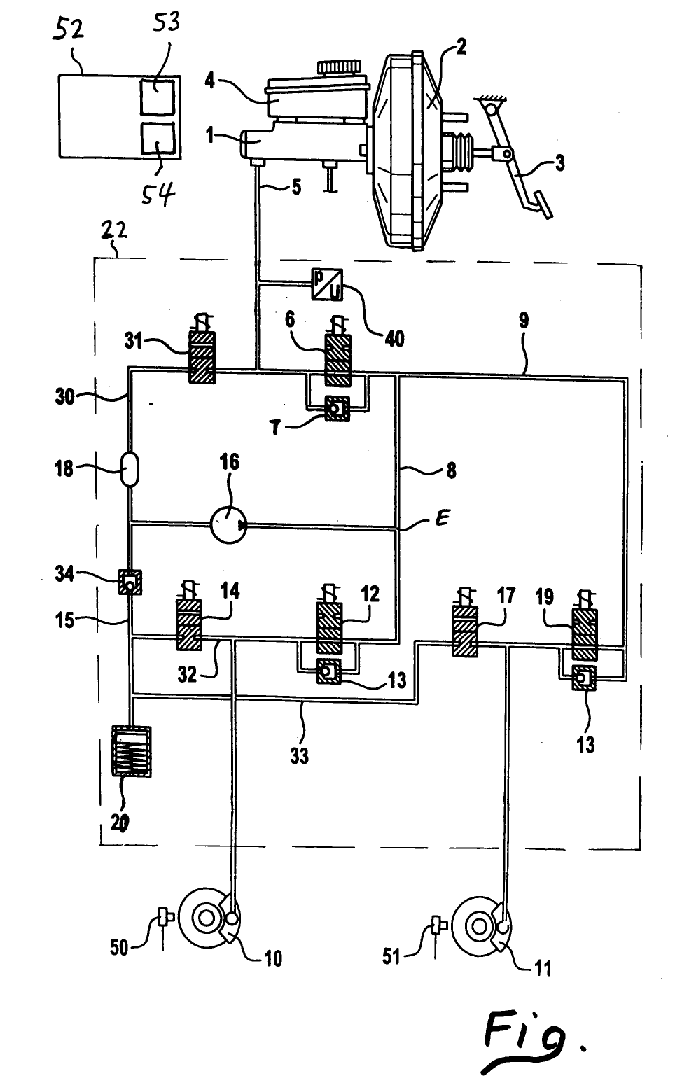

The two-circuit brake system for motor vehicles illustrated in FIG. 1 comprises an operating unit 1, e.g. a tandem master brake cylinder, and a vacuum brake booster 2 operated by a brake pedal 3. Arranged at the operating unit 1 is a reservoir 4 that contains pressure fluid volume and is connected to the working chamber of the operating unit 1 in the brake release position. The one brake circuit illustrated includes a brake line 5 connected to a working chamber of the operating unit 1 and connecting the operating unit 1 to the one hydraulic unit 22. Brake line 5 includes a separating valve 6 providing an open passage for the brake line 5 in the rest position. Connected in parallel to the separating valve 6 is a non-return valve 7 opening in the direction of the wheel brakes 10, 11. The separating valve herein is also used as a pressure modulation unit. A pressure limiting function is also realized by means of this valve 6. Said separating valve 6 is operated electromagnetically. Preferably, the separating valve is an analogized valve. Continuous, ‘analog’ adjustment of the pressure or of a pressure reduction is especially possible in this case.

Brake line 5 forks into two brake lines 8, 9 each leading to a wheel brake 10, 11. Each brake line 8, 9 contains an electromagnetically operable inlet valve 12, 19 which is open in its rest position and can be switched to assume a closed position by energization of the operating magnet. Connected in parallel to each inlet valve 12, 19 is a non-return valve 13 that opens in the direction of the brake cylinder 1. In parallel to these wheel brake circuits a so-called return delivery circuit is connected, being comprised of return lines 15, 32, 33 with a pump 16. Wheel brakes 10, 11 connect to the return line 15 by way of each one outlet valve 14, 17 via return lines 32, 33 and, hence, connect to the suction side of pump 16, whose pressure side is connected to the brake pressure line 8 at a connecting point E between the separating valve 6 and the inlet valves 12, 19.

Pump 16 is preferably configured as a reciprocating piston pump with a pressure valve (not shown) and a suction valve. Pump 16 in this arrangement is used as a pressure increase unit for generating the additional hydraulic brake force assistance. A low-pressure accumulator 20, comprised of a housing not shown with a spring and a piston, is disposed at the suction side of the pump 16. A non-return valve 34 opening towards the pump is inserted into the connection between the low-pressure accumulator 20 and the pump 16. The suction side of pump 16 is connected to a low pressure damper 18 by way of a suction line 30 and to the brake cylinder 1 by way of a change-over valve 31. Further, the brake force transmission circuit includes a pressure sensor 40 arranged in the brake line 5 between the brake cylinder 1 or change-over valve 31 and the separating valve 6. The brake cylinder pressure is detected and the introduced brake pressure determined by way of pressure sensor 40. Wheel speed sensors 50, 51 determine the wheel speeds, and the signals are sent to an electronic brake control unit 52. Associated with the electric control unit 52 is an error detection 53 and a current regulator 54 for actuating the separating valve 6.

The brake system operates as follows:

When the driver increases the brake fluid pressure in the system by way of the operating unit 1 with the vacuum brake booster 2, the electronic control unit 52 will actuate the pump for the purpose of pressure development in the wheel brakes when the point of maximum boosting of the vacuum brake booster 2 is reached or exceeded. Thus, there is a transfer from the pneumatic brake force boosting by means of vacuum brake booster 2 to brake force boosting by means of pump 16. Said pump performs the function of an active hydraulic brake force boosting. When the brake pressure introduced into the system and the wheel brakes reaches or exceeds a value and when the wheels are transferred into brake slip, the signals of the wheel speed sensors 50, 51 will command the electronic control unit 52 to initiate ABS control and to control the inlet and outlet valves accordingly.

When the pump 16 is actuated for a long period of time with the inlet valves 12, 19 closed, and when the current controller 54 has a defect, with the result that also the separating valve 6 is closed, pressure can develop that exceeds the bursting pressure of the system. A critical pressure situation may e.g. occur quickly with erroneous actuations of the separating valve in excess of roughly 15 milliseconds. According to the invention, the current regulator 54 is tested situation-responsively (i.e. while in use), which does not have any significant hydraulic effect. The result is that error detection can take place rapidly, with a high rate of error protection in addition. Accordingly, the current regulator 54 is tested by actuation with a testing current that is considerably lower than that which is necessary to induce valve movement, by determining the actual current and comparing the two values.

Preferably, it is also possible to carry out an analogous testing or monitoring operation during active control interventions at the separating valve 6, and the controlling current that is adjusted by the current regulator will replace the testing current in this case. Testing of the current regulator is then additionally performed during intervention of the current regulator by way of an actuation with the controlling current and a comparison between the controlling current and the measured actual current that is preferably measured redundantly.

A decision whether a time interval (loop, roughly 3-10 milliseconds) under review is all right, meaning without errors, is taken by error detection unit 53. This unit 53 is used for the comparison between the current specification (testing current) or a nominal current corresponding therewith and the measured actual current value transmitted.

The term ‘error’ in this context means a deviation between the nominal current and the (measured) actual current, in particular a deviation detected several times in a row, the said deviation exceeding tolerances predetermined by the current regulator and current measurement.

Testing is executed favorably by way of several measuring operations. With increasing deviations or errors, detection of the errors is possible at a correspondingly quicker rate. The actuation with a testing current is thus done over a longer period of time (testing cycle), preferably roughly 3 to 50 loops, that means 30 to 500 milliseconds approximately, and a small number of errors is also ‘accepted’.

When an error is detected, a testing cycle may also be repeated, and the faulty testing cycle is then initially evaluated as a ‘suspected error’ and an error is finally considered as identified only when further faulty testing cycles occur. To enhance the safety in detecting an error, the testing cycle is repeated several times, preferably in dependence on the percentage of errors detected within the testing cycles during a total testing time comprising several testing cycles. The assessment may e.g. be executed by a counter. The result is that a loop without errors during the entire testing time causes decrementing operations, and a loop with errors causes incrementing operations, with a hysteresis, as the case may be. When the counter exceeds a first threshold, the testing operation is repeated. When the counter exceeds a higher, second threshold, the result of the testing operation is deemed reliable, i.e. an error of the current regulator is considered as safely detected, for example. The thresholds may also be variable in dependence on the testing time.

1-12. (canceled)

13. Method for testing a current regulator of an electronically controllable valve in a hydraulic vehicle brake system, comprising the steps of:
actuating the current regulator by applying a testing current that is sufficiently small such that essentially no valve movement of the electronically controllable valve takes place, with the result that no substantial hydraulic effect is produced on the vehicle brake system.

14. Method as claimed in claim 13, wherein the electronically controllable valve is an analogized valve.

15. Method as claimed in claim 13, wherein the actuating step is carried out in times when an intervention by a regulator of the vehicle brake system is not taking place.

16. Method as claimed in claim 13, wherein the actuating step is carried out in times when a constant current is adjusted, and wherein the testing current is superimposed on said adjusted current.

17. Method as claimed in claim 13, wherein the actuating step includes a comparison between a nominal current and a measured actual current wherein said actual current is measured redundantly.

18. Method as claimed in claim 13, wherein the actuating step includes a plurality of temporally separate comparisons.

19. Method as claimed in claim 13, wherein the testing current includes individual nominal currents or purposefully adjusted current curves.

20. Method as claimed in claim 13, wherein testing current is applied prior to each application of the hydraulic brake system in order to ensure the safety of a correct functioning or timely deactivation of the current regulator.

21. Method as claimed in claim 13, wherein the electronically controllable valve includes a means for limiting the hydraulic pressure.

22. Method as claimed in claim 13, wherein the brake system includes an active hydraulic brake force boosting device, and wherein the driver introduces brake pressure into a master brake cylinder by means of an operating device, preferably a brake pedal, and wherein the pressure introduced by the driver is boosted by means of an active hydraulic pressure increase unit.

23. Method as claimed in claim 13, further including the step of testing the current regulator during an intervention of the current regulator by way of an actuation with a controlling current, and in that the testing operation includes comparing the controlling current and a measured actual current that is preferably measured redundantly.

24. Implementation of the method as claimed in claim 13 for a vehicle brake system without a mechanical/hydraulic pressure limiter.
